(19) United States
(12) Patent Application Publication
(10) Pub. No.: US 2025/0096852 A1
(43) Pub. Date: Mar. 20, 2025

(54) SYSTEMS AND METHODS FOR CONTROL SIGNALING FOR USING A RECONFIGURABLE INTELLIGENT SURFACE IN COMMUNICATION SYSTEMS

(71) Applicant: Huawei Technologies Co., Ltd., Shenzhen (CN)

(72) Inventors: Wen Tong, Ottawa (CA); Xiaoyan Bi, Kanata (CA); Jianglei Ma, Kanata (CA)

(21) Appl. No.: 18/950,578

(22) Filed: Nov. 18, 2024

Related U.S. Application Data
(63) Continuation of application No. PCT/CN2022/093639, filed on May 18, 2022.

(51) Int. Cl. H04B 7/04; H04B 7/06

(52) U.S. Cl. CPC H04B 7/04013; H04B 7/06952

(57) ABSTRACT

Aspects of the present application provide a system with a RIS panel with a unique geometrical shape surface, two RIS panels, also referred to as an RIS-pair, or a group of more than two RIS panels that are jointly controlled to aid wireless communication coverage holes.

### CROSS-REFERENCE TO RELATED APPLICATIONS

This application is a continuation of International Application No. PCT/CN2022/093639, filed on May 18, 2022, the disclosure of which is hereby incorporated by reference in its entirety.

### TECHNICAL FIELD

The present disclosure relates generally to wireless communications, and in particular embodiments, use of reconfigurable intelligent surfaces (RIS) in communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Metasurfaces have been investigated in optical systems for some time and recently have attracted interest in wireless communication systems. These metasurfaces are capable of affecting a wavefront that impinges upon them. Some types of these metasurfaces are controllable, meaning through changing the electromagnetic properties of the surface, the properties of the surface can be changed. For example, manipulation of the amplitude and/or phase can be achieved by changing an impedance or relative permittivity (and/or permeability) of the metamaterial. An example of a metasurface is a reconfigurable intelligent surface (RIS).

A controllable RIS can affect the environment and effective channel coefficients of a channel of which the RIS is a part thereof. This results in the channel being represented as the combination of an incoming wireless channel and an outgoing wireless channel and the phase/amplitude response of the configurable RIS.

### SUMMARY

The application of mmWave in 6G cellular network will be widely applied in the near future because of higher spectral efficiency, higher throughput and higher beam resolution. One impediments of mmWave communication is sensitivity to blockages caused by buildings, walls, windows and foliage, limited coverage that may cause severe path loss. Such impediments may lead to limited coverage area and dead zones. RIS assisted networks have been envisioned as an enabling technology to extend the coverage of mmWave networks by controlling the channel through the use of RISs. RISs can be installed on large flat surfaces (e.g., walls or ceilings indoors, buildings or signage outdoors) in order to reflect radio frequency (RF) energy around obstacles and create a virtual line of sight (LoS) propagation path between a transmitter and the destination.

Aspects of the present application may address problems of a single panel based RIS node that occur in real deployment scenarios, such as, but not limited to, limited coverage area, low power gain, and system throughput. While multiple separate single panel based RISs that are independently controlled may be used to deal with such problems, this solution may lead to a higher economic cost and a more complicated control process. Aspects of the present application may further extend coverage to reduce coverage holes that cannot be covered by a single RIS panel.

According to an aspect of the disclosure there is provided a method involving: sending, by a reconfigurable intelligent surface (RIS) node including at least a first portion of surface and a second portion of surface wherein the first portion of the surface can be configured to redirect a signal to the second portion of the surface, capability information of the RIS node; sending, by the RIS node, information pertaining to beam sets and/or orientation of the at least one RIS portion; receiving, by the RIS node, control signal from the base station for controlling operation of the RIS node; and redirecting, by the RIS node, signals from a user equipment (UE) to a base station or from a base station to a user equipment based on the control signal.

Optionally, wherein the controlling operation involves at least to redirect a signal from a first portion of the surface to a second portion of the surface.

In some embodiments, the capability information of the RIS includes at least one of: an indication of whether the RIS can be partitioned into multiple portions; when there are at least two RIS portions, an indication of whether the RIS portions are independently or jointly controlled; and adjustability of a surface of the at least one RIS portion.

In some embodiments, the information pertaining to beam sets includes, for each beam set, a set index value for identifying the beam set, a number of beams in the beam set and the one or more RIS portions the beam set is associated with.

In some embodiments, the information pertaining to orientation of at least one RIS portion includes at least one of: an angle between the first portion and the second portion of the at least one RIS portion; and a geometrical shape of the at least one RIS portion.

In some embodiments, the control signal for controlling operation of the RIS node includes one or more of: when there are at least two RIS portions, an indication of whether the RIS portions are independently or jointly controlled; a set index for identifying a selected beam set to be used by each RIS portions; a beam or beam group in the selected beam set to be used by each portion; an indication of a location of a UE or UE group; and a location of the UE.

In some embodiments, the control signal is configured to be sent using a semi-persistent manner or a dynamic manner.

In some embodiments, the capability information, the information pertaining to beam sets, and the control signal are sent in at least one of: a periodic manner; an aperiodic manner; and a semi-persistent manner.

In some embodiments, the method further involves receiving, by the RIS node, configuration information including phase parameter information of beam sets for the RIS node.

In some embodiments, the RIS node determines phase parameters of the beam set for a given coverage area, coverage range and cover angle.

In some embodiments, the base station determines phase parameters of the beam set for a given coverage area, coverage range and cover angle.

In some embodiments, the method further involves receiving, by the RIS node, configuration information pertaining to a target coverage area of the RIS node.

In some embodiments, the method further involves determining, by the RIS node, beam parameters for a target coverage area of the RIS node, wherein the target coverage area is configured by the base station.

In some embodiments, the method further involves selecting, by the RIS node, a beam from pre-calculated beam sets based on the UE location.

In some embodiments, the method further involves receiving, by the RIS node, configuration information pertaining to a plurality of coverage areas of the RIS node.

In some embodiments, the method further involves determining, by the RIS node, beam parameters for each of the plurality of coverage areas of the RIS node, wherein the plurality of coverage areas are configured by the base station.

In some embodiments, the method further involves selecting, by the RIS node, a beam from pre-calculated beam sets based on the UE location.

In some embodiments, the control signal from the base station includes information associated with an updated angle between the first portion and the second portion of the RIS surface and corresponding phase parameters of beam sets.

In some embodiments, the information associated with an updated angle includes, for a target coverage area, an identification of the target area, a relative angle between the first portion and the second portion of the RIS surface and an identification of one or more beams to be used by the RIS node.

In some embodiments, the control signal includes an identification of a RIS portion that is a master and a RIS portion that is a secondary, an indication of a time slot for uplink or downlink transmission, an indication of a beam for use by the master and one or more beams for use by the secondary.

In some embodiments, the method further involves receiving, by the RIS node, configuration information including phase parameter information of beam sets for the RIS node based on tuning at the RIS node.

In some embodiments, the configuration information includes a tuning mechanism for each RIS portion of the RIS node and an identification of one or more beam for use by the RIS node.

In some embodiments, the control signal includes an identification of RIS tuning information for use by the RIS node.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: receiving, by a base station, capability information of a reconfigurable intelligent surface (RIS) node including at least a first portion of surface and a second portion of surface wherein the first portion of the surface can be configured to redirect a signal to the second portion of the surface; receiving, by the base station, information pertaining to beam sets and/or orientation of the at least one RIS portion; and transmitting, by the base station, a control signal to the RIS node for controlling operation of the RIS node.

Optionally, wherein the controlling operation includes at least to redirect a signal from a first portion to a second portion.

In some embodiments, the capability information includes at least one of: an indication of whether the RIS can be partitioned into multiple RIS portions; when there are at least two RIS portions, an indication of whether the RIS portion are independently or jointly controlled; and adjustability of a surface of the at least one RIS portion.

In some embodiments, the information pertaining to beam sets includes, for each beam set, a set index value for identifying the beam set, a number of beams in the beam set and the one or more RIS portion the beam set is associated with.

In some embodiments, the information pertaining to orientation of RIS portion includes at least one of: an angle between the first portion and the second portion of the at least one RIS portion; and a geometrical shape of the at least one RIS portion.

In some embodiments, the control signal for controlling operation of the RIS node includes one or more of: when there are at least two RIS portions, an indication of whether the RIS portions are independently or jointly controlled; a set index for identifying a selected beam set to be used by each RIS portion; a beam or beam group in the selected beam set to be used by each portion; an indication of a location of a UE or UE group; and a location of the UE.

In some embodiments, the control signal is configured to be sent using a semi-persistent manner or a dynamic manner.

In some embodiments, the capability information, the information pertaining to beam sets, and the control signal are sent in at least one of: a periodic manner; an aperiodic manner; and a semi-persistent manner.

In some embodiments, the method further involves transmitting, by the base station, configuration information including phase parameter information of beam sets for the RIS node.

In some embodiments, the RIS node determines phase parameters of the beam set for a given coverage area, coverage range and cover angle.

In some embodiments, the base station determines phase parameters of the beam set for a given coverage area, coverage range and cover angle.

In some embodiments, the method further involves partitioning, by the base station, a cell into multiple target coverage areas for respective RIS portions of the RIS node; and determining the location of the UE.

In some embodiments, the method further involves transmitting, by the base station, configuration information pertaining to a target coverage area of the RIS node.

In some embodiments, the method further involves: partitioning, by the base station, a cell into multiple target coverage areas for respective RIS portions of the RIS node; and determining the location of the UE.

In some embodiments, the method further involves transmitting, by the base station, configuration information pertaining to a plurality of coverage areas of the RIS node.

In some embodiments, the method further involves determining, by the base station, phase parameters of beam sets for the RIS node based on a target coverage area of the first portion and the second portion of the RIS portion and the geometrical shape of the at least one RIS portion.

In some embodiments, the control signal from the base station includes information associated with an updated angle between an angle between the first portion and the second portion of the RIS surface and corresponding phase parameters of beam sets.

In some embodiments, the information associated with an updated angle includes, for a target coverage area, an identification of the target area, a relative angle between the first portion and the second portion of the RIS surface and an identification of one or more beams to be used by the RIS node.

In some embodiments, the control signal includes an identification of a RIS portion that is a master and a RIS portion that is a secondary, an indication of a time slot for uplink or downlink transmission, an indication of a beam for use by the master and one or more beams for use by the secondary.

In some embodiments, the method further involves determining, by the base station, phase parameters for beam sets for the RIS node, wherein the phase parameters are based on a RIS parameter tuning mechanism.

In some embodiments, the method further involves transmitting, by the base station, configuration information including phase parameter information for beam sets for the RIS node based on tuning at the RIS node.

In some embodiments, the configuration information includes a tuning mechanism for each RIS portion of the RIS node and an identification of one or more beam for use by the RIS node.

In some embodiments, the control signal includes an identification of RIS tuning information for use by the RIS node.

According to an aspect of the disclosure there is provided a device including a processor and a computer-readable medium. The computer-readable medium has stored thereon computer executable instructions that when executed cause the processor to perform a method consistent with the embodiment described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2A is a schematic diagram of a communication system in which embodiments of the disclosure may occur.

FIG. 2B is another schematic diagram of a communication system in which embodiments of the disclosure may occur.

FIG. 3A is a block diagram illustrating units or modules in a device in which embodiments of the disclosure may occur.

FIG. 3B is a block diagram of an example reconfigurable intelligent surfaces (RIS).

FIG. 4 is a block diagram illustrating units or modules in a device in which embodiments of the disclosure may occur.

FIG. 5 is an example of a signaling flow diagram for signaling between a base station, a user equipment (UE), and a RIS according to an aspect of the present disclosure.

FIG. 6 is a schematic diagram of a RIS node and multiple beam sets associated with the portions of the RIS node according to an aspect of the disclosure.

FIG. 7 is a schematic diagram of a RIS node and multiple beam sets associated with the portions of the RIS node according to another aspect of the disclosure.

FIG. 8 is an example of a signaling flow diagram for signaling between a base station, a UE, and a RIS according to an aspect of the present disclosure.

FIG. 9 is a schematic diagram of a base station sending a signal to a RIS node including two portions illustrating how the RIS portions may affect the directionality of a redirected beam according to as aspect of the disclosure.

FIG. 10 is an example of a signaling flow diagram for signaling between a base station, a UE, and a RIS according to an aspect of the present disclosure.

FIGS. 11A and 11B are example schematic diagrams of a base station and a RIS node in a cell in which the cell is partitioned into multiple sub-areas that are covered by one or more portions of the RIS node according to aspects of the disclosure.

FIG. 12 is an example of a signaling flow diagram for signaling between a base station, a UE, and a RIS according to an aspect of the present disclosure.

FIG. 13 is a schematic diagram of a RIS node including two portions and in which a first portion is configured to be adjustable with respect to a second portion according to an aspect of the disclosure.

FIG. 14 are several different examples of RIS portion shapes.

FIG. 15 is an example of a signaling flow diagram for signaling between a base station, a UE, and a RIS according to an aspect of the present disclosure.

FIG. 16 includes schematic diagrams for uplink (UL) and downlink (DL) illustrating a base station and a RIS node including two portions in which the two portions may be designated as master and secondary according to as aspect of the disclosure.

FIG. 17 is an example of a signaling flow diagram for signaling between a base station, a UE, and a RIS according to an aspect of the present disclosure.

FIG. 18 includes multiple schematic diagrams of a RIS node including two portions in which the RIS portions may be configured to reflect a beam, tune a beam, or redirect a beam by both reflection and tuning according to as aspect of the disclosure.

FIG. 19 is an example of a signaling flow diagram for signaling between a base station, a UE, and a RIS according to an aspect of the present disclosure.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channel. To extract full potential of RIS-assisted MIMO, a system architecture and more efficient scheme are provided in the present disclosure.

An RIS may include many small reflection elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

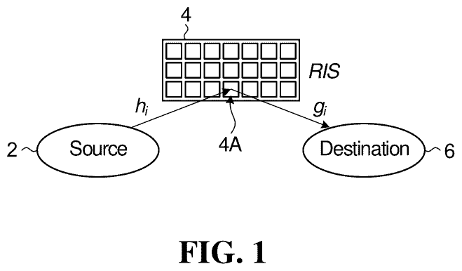

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 1 where each RIS configurable element 4a (unit cell) can change the phase of the incident wave from source such that the reflected waves from all of the RIS elements are aligned to the direction of the destination to increase or maximize its received signal strength (e.g. maximize the signal to noise ratio). Such a reflection via the RIS may be referred to as reflect-array beamforming. In some embodiments, the planar array of configurable elements, which may be referred to as an RIS panel, can be formed of multiple RIS sub-panels or portions or the RIS panel. In some embodiments, the RIS can be considered as an extension of the BS antennas or a type of distributed antenna. In some embodiments, the RIS can also be considered as a type of passive relay.

Aspects of the present disclosure provide methods and device for utilizing RIS panels in the wireless network to take advantage of the RIS capabilities, intelligence, coordination and speed, and thereby propose solutions having different signaling details and capability requirements.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hᵢ and a channel between the RIS 4 and destination 6 identified as gᵢ for the i^{th} RIS configurable element (configurable element 4a) where i∈{1, 2, 3, . . . , N*M} assuming the RIS consists of N*M elements or unit cells. A wave that leaves the source 2 and arrives at the RIS 4 can be said to be arriving with a particular AoA. When the wave is reflected or redirected by the RIS 4, the wave can be considered to be leaving the RIS 4 with a particular AoD. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

While FIG. 1 has two dimensional planar array RIS 4 and shows a channel hᵢ and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 1, or as 2) a transmitter (integrated at the transmitter) to help implement a virtual MIMO system as the RIS helps to direct the signal from a feeding antenna.

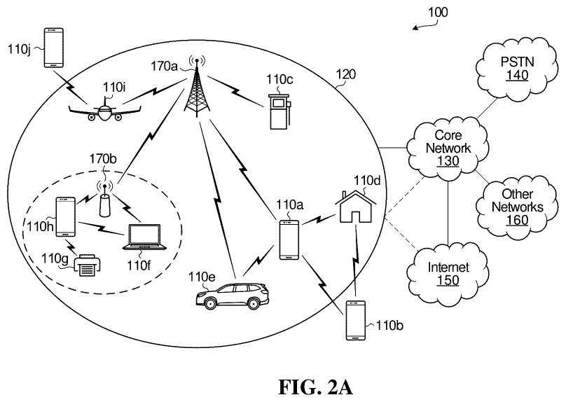

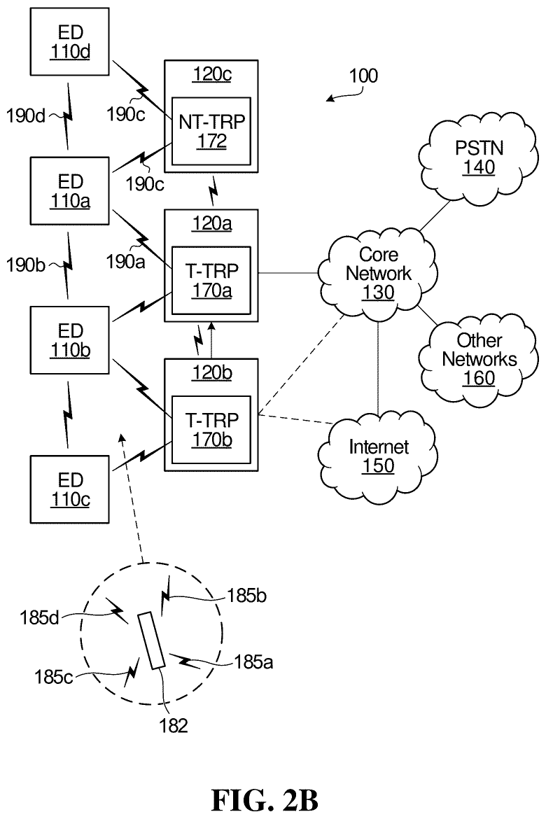

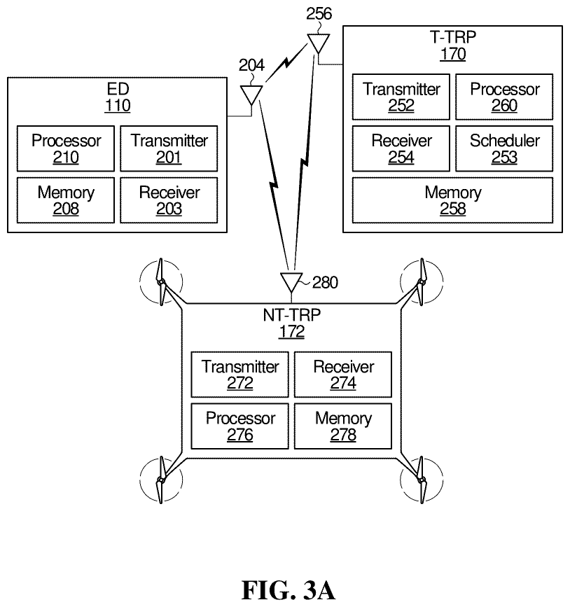

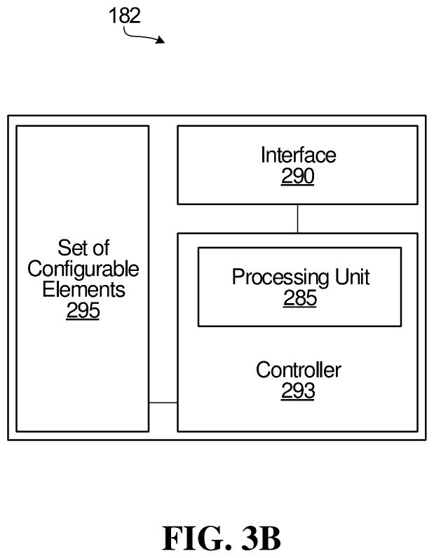

FIGS. 2A, 2B, 3A and 3B following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

Also shown in FIG. 2B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 2B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IOT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3A. FIG. 3A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 3A, a RIS may be located between the ED 110 and the NT-TRP 172 or between the ED 110 and the T-TRP 170, in a similar manner as RIS 182 is shown between the EDs 110 and base station 170b in FIG. 2B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 3B illustrates an example RIS device that may implement the methods and teachings according to this disclosure. In particular, FIG. 3B illustrates an example RIS device 182. These components could be used in the system 100 shown in FIGS. 2A and 2B, the system shown in FIG. 3A, or in any other suitable system.

As shown in FIG. 3B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 3B. The RIS 182 ultimately needs a set of configurable elements that can be configured as described to operate herein.

FIG. 3B illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

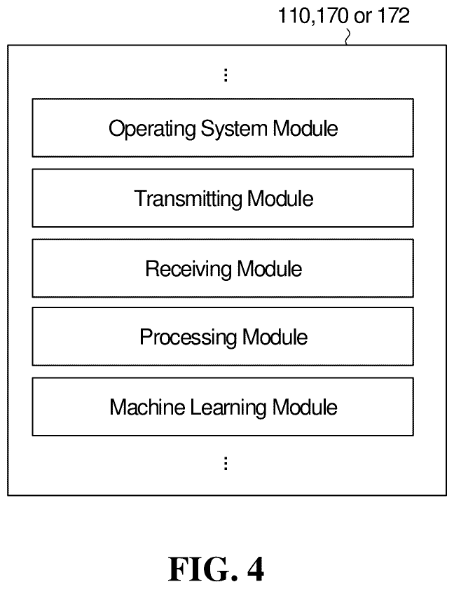

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Although a single panel based RIS node improves performance of mmWave communications, the single panel based RIS node may not completely eliminate coverage holes in some scenarios. For example, the single panel based RIS node may only serve UEs within a main beam direction of the RIS node. However, other UEs that may be located in a coverage hole are still out of service.

When compared to the single panel based RIS node, a multiple panel based RIS node can cooperatively, or jointly, further expand a beam scanning area and directions to enlarge a coverage area. As an alternative expression, a panel may be considered to be partitioned into multiple portions. Therefore, when referring to multiple panels in the description below, this may also be considered to be a panel with multiple portions where panels correspond to portions. Furthermore, by utilizing RIS nodes having surfaces with different types of geometrical shapes various deployments may be possible.

Aspects of the present application may address problems of a single panel based RIS node that occur in real deployment scenarios, such as, but not limited to, limited coverage area, low power gain, and system throughput. While multiple separate single panel based RISs that are independently controlled may be used to deal with such problems, this solution may lead to a higher economic cost and a more complicated control process. Aspects of the present application may further extend coverage to reduce coverage holes that cannot be covered by a single RIS panel.

Aspects of the present application provide a system with a RIS panel with a unique geometrical shape surface, two RIS panels, also referred to as an RIS-pair, or a group of more than two RIS panels that are jointly controlled to aid wireless communication coverage holes, to further extend the coverage, to increase signal power, or to improve system throughput.

Aspects of the present application provide methods to control multiple panel RISs that are part of a single RIS node and aid in transmission of signals based on different types of RIS-related wireless communication. Aspects of the present application may also provide a flexible system architecture, a signaling mechanism for implementing the flexible system architecture, and a working mode of a multiple panel RIS system.

With regard to the flexible system architecture, RIS nodes may be classified as either single panel based or multiple panels based, or multiple portions of the single panel based. For the single panel RIS node, the geometrical shape of the panel and the geometrical shape and orientation of the panel may be adjusted. For the multiple panels RIS node, an orientation of all panels or part of panels may be adjusted. For the multiple panel RIS node, or multiple RIS portion of the single panel, the relative angles between the panels may be adjusted, if desired or allowable, based on various scenarios. The angles range from 0 to 180 degrees in a plane perpendicular to the RIS panels.

A RIS node may be assigned a single RIS ID regardless of whether the RIS node consists of a single panel with multiple portions or multiple panels. As a result, there may be two types of channels considered in this system: a single control channel and a single access channel in which the control channel is used to transmit control signaling and the access channel is used by a node or device to initiate a data transfer to network. Based on the use of a single RIS ID, the network may treat the RIS node, regardless of how many panels, as a single entity. Having these two types of channels may reduce the complexity of the control process.

With regard to the signaling mechanism, the RIS node may report the state of the RIS node parameters, such as the RIS node capacity, relative angle between RIS panels, a number of RIS panels, whether the RIS panels can be independently or jointly controlled, etc.

A relative angle between two or more panels of the RIS node may be adjusted by controlling signals and such adjustment may play a role in improving system performance. In some embodiments, such as when the relative angle at the RIS node is adjustable, the base station may send configuration information to the RIS node that includes relative angle information to allow the RIS node to set the adjustable angle to the relative angle included in the configuration information. In some embodiments, the RIS node may be able to determine the relative angle(s) based on spatial coverage indication or coverage area (location) indication.

Based on the determined relative angle(s), the RIS node then determines the phase information needed at the panels to achieve the determined relative angle(s). A phase adjustment for multiple panels of the RIS node may be different from that of a single panel RIS node. For example, the phase can be adjusted for tuning or steering a beam, which involves reflecting the beam, but reflection that is steered in a particular direction, or simply reflecting the beam. The phase information, which may also be referred to as phase parameter information in this disclosure, may be information that controls or drives the elements of the RIS panels to achieve a particular directionality of a redirected beam. As will be described in further detail below, the phase parameter information driving the RIS elements of the RIS panels may result in a simple reflection or a tuning that can steer the beam differently than just a simple reflection. In some embodiments, the base station may determine phase parameter information that when provided to the RIS node may be used to directly drive the RIS elements of the RIS panel. In some embodiments, the base station may determine phase information and provide information to the RIS node that may be used by the RIS node to determine how drive the RIS elements of the RIS panels to achieve a desired directionality.

In a DL scenario that includes transmission from the base station to a UE, the base station may send a single signaling to control two or more panels of a RIS node that includes simultaneously tuning the state of the RIS. For example, the base station may send phase parameters to be used by the RIS node for phase tuning of the RIS panels. In some embodiments, the base station may send a single control signaling with a set of phase parameters for one of the RIS panels and then phase parameters for one or more other RIS panels may be implicitly derived by the configuration. In some embodiments, the base station may send a single control signaling with two sets of phase parameters, one set of phase parameters corresponding to each of the respective RIS panels. In some embodiments, the sets of phase parameters may be based on UL beam training using signaling from the UE to the base station.

In some embodiments, when one of the RIS panels of the RIS node is a master and the other panel(s) is a secondary, the phase parameters for adjustment may be dynamically configured by the base station. Configuring a panel as a master and one or more other panel as a secondary may be implicitly configured in a UL time slot or a DL time slot. The UL time slot may be, for example, in physical uplink control channel (PUCCH) or physical uplink shared channel (PUSCH) and the DL time slot may be, for example, in physical downlink control channel (PDCCH) or physical uplink shared channel (PDSCH). For example, a first RIS panel that a beam impinges upon for DL is a master and a second RIS panel that the first RIS panel redirects the beam toward is a secondary.

With regard to the working mode of multi-panel RIS system, the working mode of the RIS-pair system may be dynamically indicated by the base station simultaneously controlling all of the RIS panels to adjust the parameters of the respective RIS panels (Mode 1) or the base station can independently control either one of the RIS panels when only one of the RIS panels of the RIS node is used to reflect signals from the base station to the UE (Mode 2).

When the RIS node contains more than two RIS panels, a combination of RIS panels may be grouped together in a semi-persistent manner or dynamic manner by the base station.

In some embodiments, the structure of multiple panels in the RIS node is static with respect to one another. The structure being statics means that the angle between a pair of RIS panels is fixed. This fixed angle ranges from 0 to 180 degrees in a plane perpendicular to one of the RIS panels. Phase parameter information for controlling the panels of the RIS node for redirection of beams included in a beam set may be previously configured by the RIS node for a given area/range/angle.

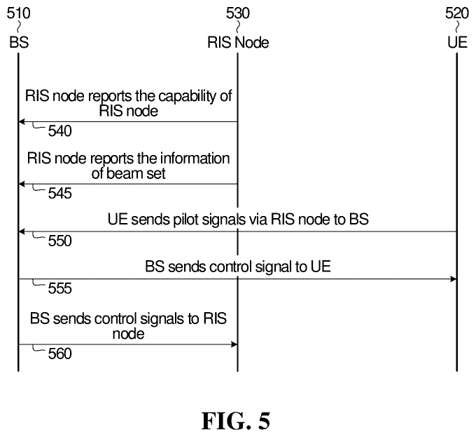

FIG. 5 illustrates an example of signal flow amongst a base station (BS) 510, a UE 520 and a single panel partitioned into multiple portion or multiple panel RIS node 530.

At step 540, in a first UL time slot, which may be PUCCH or PUSCH, the RIS node 530 sends a report to notify the base station 510 about the capability of the RIS node 530 in at least one of a periodic, aperiodic and semi-persistent manner. A report is used here as a general term that may also be considered as feedback from the RIS node to the base station.

For a periodic manner, the RIS node 530 reports the capability information periodically in respect of certain time units (e.g., subframes/slots/symbols) based on a configured periodicity and a time unit offset. In some embodiments, both the periodicity and the offset are in terms of a time unit number. The parameters of periodicity and time unit offset may be semi-statically configured.

For an aperiodic manner, the RIS node 530 makes a single report that may happen in any type of time unit. The report only happens once per triggering event. The aperiodic transmission is explicitly informed, or triggered, for a given reporting occurrence by means of dynamic signaling.

For a semi-persistent manner, like the periodic manner, resources for semi-persistent reporting are semi-statically configured. The resource are configured using parameters including periodicity and a time unit offset. However, unlike the periodic case, dynamic signaling is needed to activate, and may be needed to deactivate, the semi-persistent reporting.

In some embodiments, the information about the capability of the RIS node 530 may include an indication of whether the RIS node 530 may be partitioned into multiple RIS panels. In some embodiments, the information about the capability of the RIS node 530 may include an indication of whether the RIS panels of the RIS node 530 may be at least one of independently controlled and jointly controlled

At step 545, in a second UL time slot, which may also be PUCCH or PUSCH, the RIS node 530 reports an orientation of the RIS node 530 and the information of beam sets that is determined by the RIS node 530 for each individual RIS panel, or groups of panels, of the RIS node 530 by a multi-bit signal in at least one of a periodic, aperiodic and semi-persistent manner. The orientation of the RIS node 530 may refer to an angle between one of the RIS panels of the RIS node 530 and a reference plane that is agreed upon by the base station, or network, and the RIS node 530. Information regarding particular beam sets may include a beam set identifier, such as an index value, a number of beams associated with the beam set and whether the beam set is for a particular RIS panel or multiple panels of the RIS node 530. An example of one possible beam set for a RIS node 530 having two RIS panels, i.e. a RIS-pair, is:
Beam set #1, having N beams, for use with RIS panel 1 only
Beam set #2, having M beams, for use with RIS panel 2 only
Beam set #3, having K beams, for use with RIS panels 1 and 2.
The values of N, M and K are integer values of one or more.

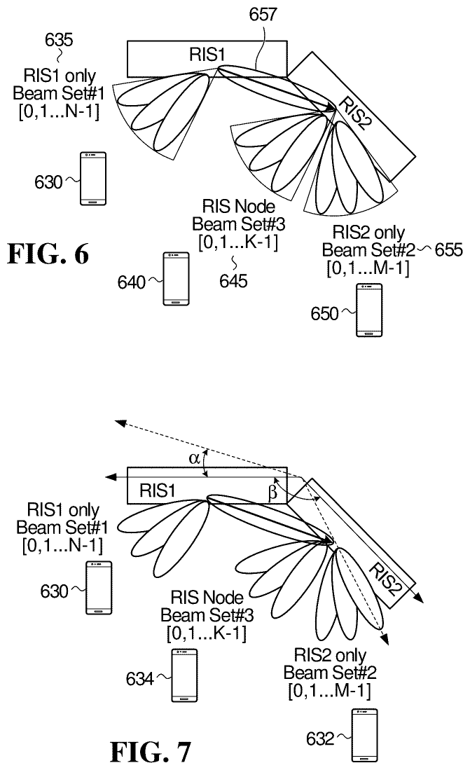

FIG. 6 illustrates an example of an RIS node that includes two RIS panels, RIS1 and RIS2. Each panel has a surface. In proximity to the RIS node there is also shown three UEs, 630, 640 and 650. In order to send a signal to the first UE 630 from RIS1, any of the beams of Beam Set #1 635 (which includes beams 0 to N−1, three of which are shown in the direction of UE 630) can be used. In order to send a signal to the second UE 650 from RIS2, any of the beams of Beam Set #2 655 (which includes beams 0 to M−1, three of which are shown in the direction of UE 650) can be used. In order to send a signal to the third UE 640 from RIS1 and RIS2, any of the beams of Beam Set #3 645 (which includes beams 0 to K−1, three of which are shown in the direction of UE 640) can be used. The beams in Beam Set #3 may be a result of redirecting a signal from RIS1 to RIS2 using beam 657.

Referring again to FIG. 5, at step 550, in a third UL time slot, which may also be PUCCH or PUSCH, the UE 520 may send reference signals, which may be pilot signals, via redirection by the RIS node 530 to the base station 510 to report the information pertaining to the UE 520. For example, the UE 530 may report channel state information (CSI) of the channel between the base station 510 and the UE 520, capacity of RIS panels used to redirect the signal between the base station 510 and the UE 520, whether RIS panels are needed for communication between the base station 510 and the UE 520, and other RIS-related information. It is assumed that the UE 520 knows the location of the RIS panels of the RIS node 530, or at least of the RIS node 530, as a result of an access process or by other sensing techniques.

It should be noted that the time slot for the UE 520 and the RIS node 530 to send signals to the base station 510 are independent of one another. However, it is to be understood that the information transmitted in the first and second time slots and the third time slot may be transmitted in the same or different times during the UL.

At step 555, in a DL time slot, which may be PDCCH or PDSCH, the base station 510 sends a single control signaling to the UE 520 including configuration information for identifying a time-frequency resource that may be used when a signal is being sent to the UE via the RIS node 530 and other information pertaining to the RIS node 530 and the RIS panels that the UE 520 may need for receiving a signal that is redirected by the RIS 530.

At step 560, the base station 510 sends a single control signaling to the RIS node 530 including configuration information for beam measurement (BM), channel state information (CSI), and data transmission that the RIS node may need to know about a signal being transmitted by the base station 510. This control signaling may contain at least beam set indices or phase configuration information for one or more panels of the RIS node 530. In some embodiments, other additional configuration information may be sent as needed. The control signaling may be sent in at least one of a periodic, aperiodic or semi-persistent manner. Two examples of control signaling are provided below, one example for semi-persistent configuration and one for dynamic configuration.

While steps 555 and 560 are shown in a particular order, it is to be understood that these steps could be implemented in a different order or substantially simultaneously.

In a particular example for a semi-persistent configuration, the mode selection is sent using radio resource control (RRC) signaling and beam selection is sent in downlink control information (DCI) or a media access control-control element (MAC-CE). The mode selection indicates whether each RIS panel is individually controlled or jointly controlled. The beam selection indicates a particular beam from a particular beam set. Table 1 illustrates an example of how the mode selection and beam selection may be provided in a semi-persistent configuration. Reference to beam sets 1, 2 and 3 in Tables 1 and 2 are used in a manner consistent with the examples of FIGS. 6 and 7, but are not intended to be limited to these examples.

TABLE 1
Semi-persistent configuration

| | | Beam selection in DCI or |
|---|---|---|
| | Mode selection in RRC | MAC CE |
| Independent | RIS1 or RIS2 only | Beam n in set1 or Beam m in |
| control | | set2 |
| Independent | RIS1 + RIS2 | Beam n in set1; Beam m in set2 |
| control | | |
| Joint control | Both panels of RIS | Beam k in set3 |
| | node | |

In a particular dynamic control signaling configuration, panel selection and beam selection are sent in DCI or MAC CE. In some embodiments, dynamic configuration is more flexible than semi-persistent configuration, but may use more air interface resources. Table 2 illustrates an example of how the mode selection and beam selection may be provided in a dynamic configuration.

TABLE 2
Dynamic control signaling

| | Panel selection in DCI | Beam selection in DCI or |
|---|---|---|
| | or MAC CE | MAC CE |
| Independent | RIS1 or RIS2 only | Beam n in set1 or Beam m in |
| control | | set2 |
| Independent | RIS1 + RIS2 | Beam n in set1; Beam m in set2 |
| control | | |
| Joint control | Both panels of RIS node | Beam k in set3 |

In some embodiments, the coverage area may be extended and the UE experience improved for a RIS node with multiple panels as compared with a traditional single panel RIS deployment.

FIG. 7 illustrates an example of an RIS node that includes two RIS panels, RIS1 and RIS2, in which the relative angle between the RIS panels is expressed as the angle β and an orientation angle of the RIS node is expressed as the angle α. The relative angle β between RIS panels RIS1 and RIS2 in not necessarily fixed in embodiments described below, but may be adjustable to potentially obtain a larger coverage area. The remainder of the elements in FIG. 7 are similar to those shown in FIG. 6.

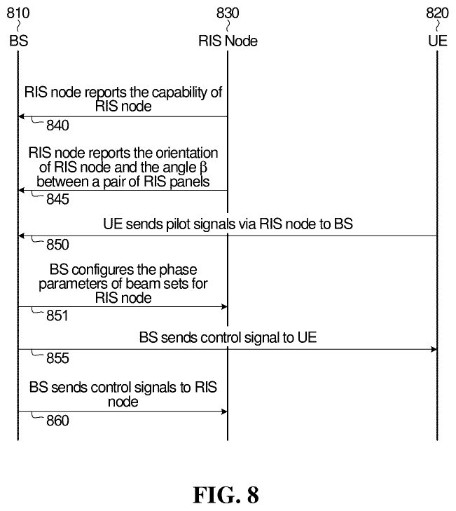

While the RIS node in FIG. 7 is similar to the RIS node in FIG. 6, the following method described with regard to FIG. 8 is different from that of FIG. 5 in that a beam set may be selected at the base station and/or the phase parameters for the RIS are determined at the base station.

FIG. 8 illustrates an example of signal flow amongst a base station (BS) 810, a UE 820 and a single panel partitioned into multiple portion or multiple panel RIS node 830.

Step 840 is similar to step 540 in FIG. 5.

At step 845, in a second UL time slot, which may be PUCCH or PUSCH, the RIS node 830 reports an orientation (a) of the RIS node 830, relative angle (B) of RIS panels of the RIS node 830, and the information of beam sets for each individual RIS panel or groups of panels of the RIS node 830 by a multi-bit signal in at least one of a periodic, aperiodic and semi-persistent manner. With respect to FIG. 7, the orientation of the RIS node 830 refers to an angle between the first RIS panel RIS1 and a reference plane that is agreed upon in the communication system. For example, a standard vertical plane may be a vertical plane where the base station is located. The relative angle of the RIS node 830 refers to the angle between RIS panels RIS1 and RIS2. If there are more than two panels, the relative angle may be an angle between one or more pairs of panels that are used to redirect a beam.

Step 850 is similar to step 550 in FIG. 5.

At step 851, after receiving reports from the RIS node 830 and the UE 820, the base station 810 determines the phase parameters or selects indices of beam sets for the RIS node 830 based on the information from the RIS node 830 and the UE 820 and sends configuration information including the phase parameters or selected indices of beam sets to the RIS node 830. Some possible approaches to determine the phase parameters for one or more panel of the RIS node 830 are provided below. However, other approaches may be used as well. Phase parameters refer to information that may be used to configure the RIS panels to redirect a beam in a desired direction. This could be configuration information that could be used to directly drive the RIS panels, or information that could be used by the RIS node to generate the configuration information used to drive the RIS panels.

In some embodiments, the base station 810 determines the phase parameters of one or more panel of the RIS node 830 based on a target coverage hole and an orientation of the RIS node 830. In some embodiments, the instantaneous CSI between the base station 810, RIS node 830 and UE 820 may be an input used for determining the phase parameters for the one or more panel of the RIS node 830 by the base station 810. In some embodiments, the phase parameters of beam sets for RIS1 and/or RIS2 of the RIS node 830 may only be predesigned by the RIS node 830.

The example below provides an example of phase parameters for respective beam indices:
The phase parameters of Beam set #1, N beams for RIS1 only
The phase parameters of Beam set #2, M beams for RIS2 only
The phase parameters of Beam set #3, K beams for RIS1 & RIS2 only

$$[ {RIS}_{1} , {RIS}_{2} ] = [ ( {Φ}_{1} , {Θ}_{1} ) , ( {Φ}_{2} , {Θ}_{2} ) … ( {Φ}_{K} , {Θ}_{K ,} ) ]$$

ϕ_{K} is a diagonal matrix which denotes the phase parameters of beam k for RIS1. θ_{K} is a diagonal matrix which denotes the phase parameters of beam k for RIS2.

Steps 855 and 860 are similar to steps 555 and 560 in FIG. 5. While steps 855 and 860 are shown in a particular order, it is to be understood that these steps could be implemented in a different order or substantially simultaneously.

Two examples of control signaling that may be sent in step 860 are provided below, one example being for semi-persistent configuration and one for dynamic configuration.

In a particular example for a semi-persistent configuration, the mode selection is sent using RRC signaling and beam selection is sent in DCI or MAC-CE. Table 3 illustrates an example of how the mode selection and beam selection may be provided in a semi-persistent configuration. Reference to beam sets 1, 2 and 3 in Tables 3 and 4 are used in a manner consistent with the examples of FIGS. 6 and 7, but are not intended to be limited to these examples.

TABLE 3
Semi-persistent configuration

| | Mode selection in | Beam selection in DCI or |
|---|---|---|
| | RRC | MAC CE |
| Independent | RIS1 or RIS2 only | Beam n in set1 or Beam m |
| control | | in set2 |
| Independent | RIS1 + RIS2 | Beam n in set1; Beam m |
| control | | in set2 |
| Joint control | RIS-pair | Beam k in set3 |

Dynamic control signaling, which refers to the design that both panel selection and beam selection is in DCI or MAC CE. Compared with semi-persistent configuration, dynamic signaling may be more flexible, but may need more resources. In a particular dynamic control signaling configuration, panel selection and beam selection are sent in DCI or MAC CE. Table 4 illustrates an example of how the mode selection and beam selection may be provided in a dynamic configuration.

TABLE 4
Dynamic control signaling

| | Panel selection in DCI | Beam selection in DCI or |
|---|---|---|
| | or MAC CE | MAC CE |
| Independent | RIS1 or RIS2 only | Beam n(m) in set1(2) |
| control | | |
| Independent | RIS1 + RIS2 | Beam n in set1; Beam m in |
| control | | set2 |
| Joint control | RIS-pair | Beam k in set3 |

In some embodiments, the performance of a target area may be improved by adjusting the relative angle β between a pair of panels of the RIS node. Given a specific UE or target area, the phase parameters and the angle parameters may be optimized by the base station, which may lead to a higher signal-to-noise ratio (SNR) or capacity for the UE.

In some embodiments, a coverage area of the RIS node, or at least one of the RIS panels of the RIS node, is partitioned into several areas based on some criteria of choosing a beam index associated with a beam, the criteria may be a coverage angle or communication environment. Such an approach may involve the base station and the RIS node storing a common agreed upon beam ID or set of beam IDs, but may result in the RIS node needing to be able to map a target coverage angle to a beam or a set of beams.

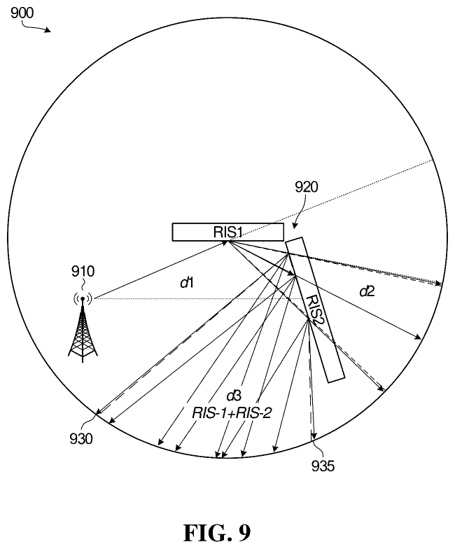

FIG. 9 illustrates an example of a base station 910 and a RIS node 920, having two RIS panels RIS1 and RIS2 in a cell area 900. A beam d1 transmitted by the base station 910 is illustrated being redirected by RIS1 in the direction of RIS2 in the form of beam d2. Beam d2 is illustrated being redirected by RIS2 in the form of beam d3. Depending how beam d1 is redirected (reflected, tuned or both) by RIS1, and then how beam d2 is redirected (reflected, tuned or both) by RIS2, there is a wide range of coverage provided by the combination of RIS1 and RIS2. Ray tracing shown in FIG. 9 illustrates that beam d1 can cover an angular range indicated from a first point 930 along an edge of the cell area 900 to a second point 935 along the edge of the cell area 900 depending on the beam parameters selected for RIS1 and RIS2.

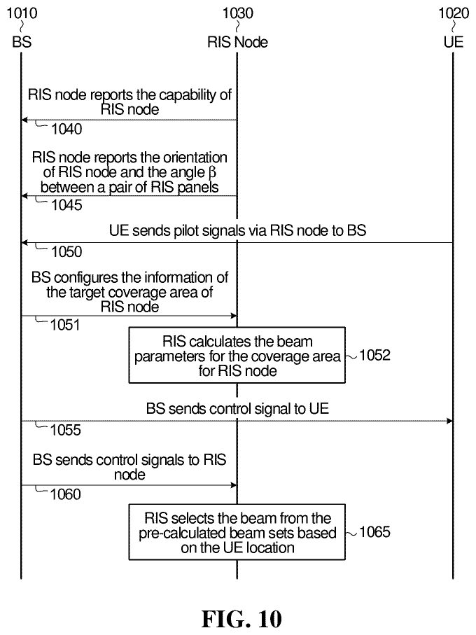

FIG. 10 illustrates an example of signal flow amongst a base station (BS) 1010, a UE 1020 and a single panel partitioned into multiple portion or multiple panel RIS node 1030.

Step 1040 is similar to step 540 in FIG. 5. Step 1045 is similar to step 845 in FIG. 8. Step 1050 is similar to step 550 in FIG. 5 or step 850 in FIG. 8.

At step 1051, after receiving reports from the RIS node 1030 and the UE 1020, the base station 1010 determines configuration information about a target coverage area of each individual RIS panel and groups of two or more RIS panels based on the feedback information from the RIS report and sensing information and sends the configuration information to the RIS node 1030. Examples of the feedback information may include the RIS node capability, CSI or UE locations.

In some embodiments, the base station 1010 partitions the cell or a part of cell into several areas which will be a target coverage area of each individual RIS panel and groups of two or more RIS panels. In some embodiments, the base station 1010 may derive the target coverage area of groups of two or more RIS panels. In some embodiments, the base station 1010 may determine a location of the UE 1020, assisted with information from the RIS node 1030 and sensing information.

At step 1052 the RIS node 1030 uses the configuration information received from the base station 1010 to aid in determining the beam parameters for the coverage area for the panels of the RIS node 1030.

Step 1055 is similar to step 555 in FIG. 5 or step 855 in FIG. 8.

At step 1060, the base station 1010 sends a single control signaling to the RIS node 1030 for BM/CSI/Data transmission and to allow the RIS node 1030 to select the beam from the pre-calculated beam sets based on the information from the control signaling for one or more RIS panels of the RIS node. The configuration information in this control signaling may contain at least the location of the target UEs or an area range of on or more target UEs. In some embodiments, other information may be sent as well. Relationships of UE information and beam index are shown in Table 5 for a single UE case and Table 6 below for a group UE case. It should be noted that the locations of the UEs are within the target area of the RIS panels. Reference to particular UEs or UE groups, and the UE location information in Tables 5 and 6 are not intended to be limited to these examples.

TABLE 5
Single UE case

| | UE information (Distance | |
|---|---|---|
| | and angle) | Beam index for RIS-pair |
| UE1 | D: 20 m A: 50° | 2 |
| UE2 | D: 25 m A: 40° | 2 |
| UE3 | D: 100 m A: 90° | 8 |

TABLE 6
Group UE case

| | UE information (Distance | Beam index for |
|---|---|---|
| | and angle) | RIS-pair |
| UE group1 | D: 10 m to 20 m A: 40° to 50° | Beam group1: 0~4 |
| UE group2 | D: 30 m to 40 m A: 40° to 50° | Beam group2: 2~6 |
| UE group3 | D: 100 m to 200 m A: 90° to 100° | Beam group3: 8~12 |

The control signaling shown in Tables 5 and 6 may be sent in a periodic, aperiodic and semi-persistent manner. In embodiments using dynamic control signaling, configuration information in the tables may be included in DCI or MAC CE.

Once the RIS node 1030 has received the configuration information in step 1060, at step 1065, the RIS node 1030 may select a beam from the pre-calculated beam sets based on the location of the UE 1020 provided in the configuration information.

While steps 1055 and 1060 are shown in a particular order, it is to be understood that these steps could be implemented in a different order or substantially simultaneously.

In some embodiment, when the base station is used to partition the target coverage area of the RIS node into several small target areas, this may provide a benefit of the beam index or phase parameters being associated with the partitioned target areas. As a result, the computation complexity of beam parameters and the size of codebooks for the RIS may be reduced. Another benefit may be, with regard to the control process, the base station only needs to transmit the location of the UE instead of transmitting complicated signals containing phase weight or CSI.

In some embodiments, a cell area may be partitioned into several sub-areas based on a combination of RIS panels with respect to various target areas. Such an approach may involve the base station and the RIS node storing a common agreed upon beam ID, but may result in the RIS node needing to be able to handle simple operations.

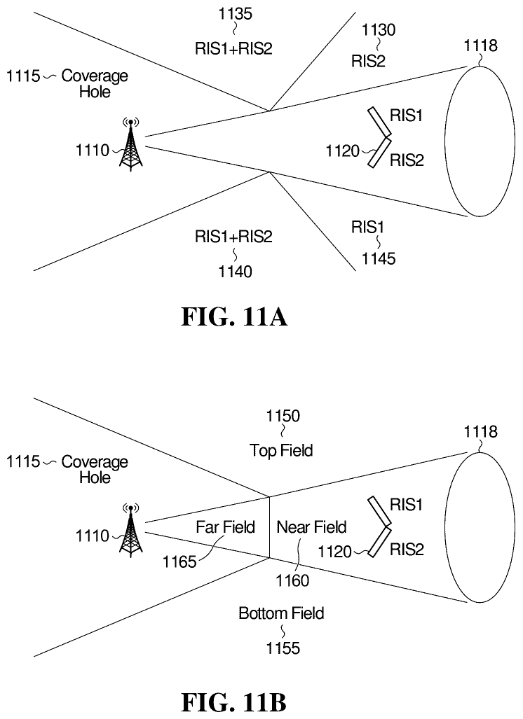

FIG. 11A illustrates an example of a base station 1110 and a RIS node 1120, having two RIS panels RIS1 and RIS2. The cell area is partitioned into an area 1145 that is covered by RIS1, an area 1130 that is covered by RIS2, areas 1135, 1140 that are covered by RIS1 & RIS2, area 1118 covered by the base station only, and areas that are not covered by RIS1 or RIS2 1115. FIG. 11B illustrates an alternative partitioning of the cell area for the RIS node, which is based on the criteria of distance, i.e. the areas being identified as top field 1150, bottom field 1155, near field 1160, far field 1165 and coverage hole areas 1115 that are not covered by the RIS node. The designations of top, bottom, etc. are simply for ease of description and it is to be understood that alternative designations may be used.

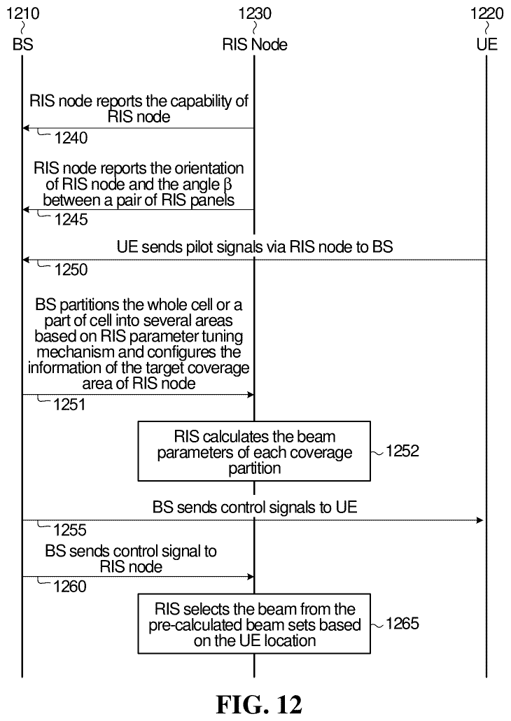

FIG. 12 illustrates an example of signal flow amongst a base station (BS) 1210, a UE 1220 and a single panel partitioned into multiple portion or multiple panel RIS node 1230.

Step 1240 is similar to step 540 in FIG. 5. Step 1245 is similar to step 845 in FIG. 8. Step 1250 is similar to step 550 in FIG. 5 and step 850 in FIG. 8.

At step 1251, after receiving reports from the RIS node 1230 and the UE 1220, the base station 1210 determines configuration information pertaining to a target coverage area of individual RIS panels and groups of one or more RIS panels based on RIS feedback information and sensing information and sends the configuration information to the RIS node 1030. Examples of the RIS feedback information may include parameters such as the RIS node capacity, CSI or UE locations. With regard to the RIS node shown in FIG. 11A having two RIS panels, the configuration information determined by the base station 1210 pertaining to a target coverage area may be for each individual RIS panel and the pair of RIS panels in combination. The base station 1210 may partition the cell, or a part of the cell, into several areas which will be the target coverage area of each individual RIS panel and the pair of panels in combination. In some embodiments, the partitioning may be based on RIS parameter tuning to enable the RIS panels for reflection only, tuning only, or redirection that includes both reflection and tuning. In some embodiments, the spatial coverage area may be provided to the RIS node 1230 in a table that provides quantization of the area. In some embodiments, the base station may derive the target coverage area for only the pairs of RIS panels of the RIS node only as opposed to individual panels. In some embodiments, the base station may obtain the location of the UE 1220 with assistance from information from the RIS node and sensing information.

At step 1252 the RIS node 1230 uses the configuration information received from the base station 1210 to aid in determining the beam parameters for the coverage area for the panels of the RIS node 1230.

As illustrated in FIG. 11A, the entire coverage area is partitioned in to five areas: RIS1 coverage area 1145, RIS2 coverage area 1130, RIS1 and RIS2 coverage areas 1135 and 1140, base station only coverage area 1118, and coverage hole areas 1115. The first three areas are the focus of information that is provided to the RIS node 1210. Table 7 shows an example of one possible relationship of coverage area, tuning mechanism and phase parameters of beam sets. Reference to tuning mechanism and beam index information in Table 7 are not intended to be limited to these examples.

TABLE 7

| | | Beam index for RIS- |
|---|---|---|
| Coverage area | Tuning mechanism | pair |
| RIS1 | RIS1 reflection; RIS2 muting | 0, 1, 2, 3 |
| RIS2 | RIS1 muting; RIS2 reflection | 4, 5, 6, 7 |
| RIS1 + RIS2 | RIS1 tuning; RIS2 reflection | 8, 9, 10, 11 |
| RIS1 + RIS2 | RIS1 reflection; RIS2 tuning | 12, 13, 14, 15 |

Table 8 is another example of configuration information that could be provided to the RIS node 1230 by the base station 1210 based on the coverage area partitioning in FIG. 11B. Reference to coverage area and beam index information in Table 8 are not intended to be limited to these examples.

TABLE 8

| Coverage area | Beam index for RIS-pair |
|---|---|
| Near field | 0, 1, 2, 3 |
| Far field | 4, 5, 6, 7 |
| Top field | 8, 9, 10, 11 |
| Down field | 12, 13, 14, 15 |

While Tables 7 and 8 show two different examples of configuration information tht may be provided to the RIS node, it is to be understood that configuration information in other forms may be provided to the RIS node based on other scenarios and still be considered within the scope of this disclosure.

The control signaling shown in Tables 7 and 8 may be sent in a periodic, aperiodic and semi-persistent manner. In embodiments using dynamic control signaling, configuration information in the table may be included in DCI or MAC CE.

Step 1255 is similar to step 555 in FIG. 5.

At step 1260, the base station sends a single control signaling to the RIS node 1230 for BM/CSI/Data transmission and to allow the RIS node 1230 to select the beam from the pre-calculated beam sets based on the information from the control signaling for one or more RIS panels of the RIS node 1230. The control signaling may be consistent with the configuration information in Tables 7 and 8 above. The configuration information in this control signaling may contain at least the location of the target UEs or an area range of the target UEs. In some embodiments, other information may be sent as well. This control signaling may contain at least the location of the UE, but other information may be sent as well based on different scenarios.

While steps 1255 and 1260 are shown in a particular order, it is to be understood that these steps could be implemented in a different order or substantially simultaneously.

Once the RIS node 1230 has received the configuration information in step 1260, at step 1265, the RIS node 1230 may select a beam from the pre-calculated beam sets based on the location of the UE 1220 provided in the configuration information.

In some embodiments, compared with the previously described embodiments that pertain to location information of one or a group of UEs, an advantage of the embodiment described with regard to FIG. 12 is to extend the RIS node coverage area to the whole coverage area of a cell. In such embodiments, the base station partitions a coverage area of a cell into several sub-areas that will be the target coverage area of each individual RIS panel and or groups of RIS panels of the RIS node. In some embodiments, this may result in the RIS node determining only the beam parameters for the area that a given panel is responsible for. As a result, the computation complexity of beam parameters and the size of codebooks for the RIS may be reduced. In some embodiments, the base station may transmit only the location of the UE instead of complicated signals containing phase weight or CSI, and then the RIS node can determine the associated beam parameters based on UE location.

In some embodiments, a RIS panel may be made of a meta-material, which allows the RIS panel have the ability to change geometrical shape to adjust to various communication environments. A RIS node having one or more of this type of RIS panel may provide more coverage area as compared to a RIS panel without such ability.

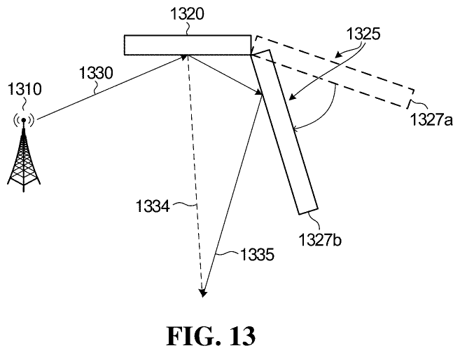

FIG. 13 is an example of a RIS panel that may appear to have a flat planar surface at some times, but at other times a first part 1325 of the RIS panel can be moved with respect to a second part 1320. A beam 1330 transmitted from the base station 1310 can be redirected by the second part 1320 directly to a destination as shown by beam 1334. The redirection here may result from tuning of second part 1320, Alternatively, the first part 1325 can be repositioned from a first position 1327a to a second position 1327b, which allows the second part 1320 of the panel to redirect the beam 1330 towards the first part 1325 of the panel, when in the second position 1327b, that redirects the beam to the destination as shown by beam 1335. The redirection here may result from reflection or tuning of second part 1320 and reflection or tuning of first part 1325

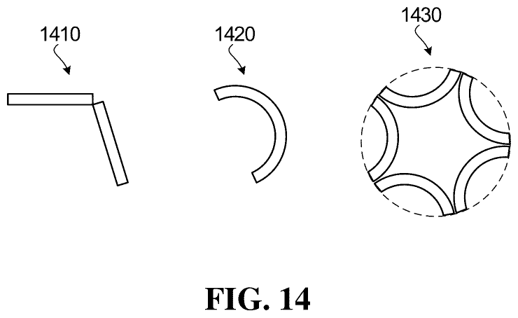

FIG. 14 shows three different example surfaces of an RIS panel. A first example is a panel 1410 of similar type to that shown in FIG. 13 that has a two parts that can be moved with respect to one another. A second example is a panel 1420 having a semi-circular or concave surface. Repositioning of this panel may amount to rotating the panel to redirect beams in a different direction or changing the radius of curvature of the surface. A third example is a panel 1430 having a multiple semi-circular or concave surfaces arranged in a ring. Repositioning of this panel may amount to rotating the ring to redirect beams in a different direction.

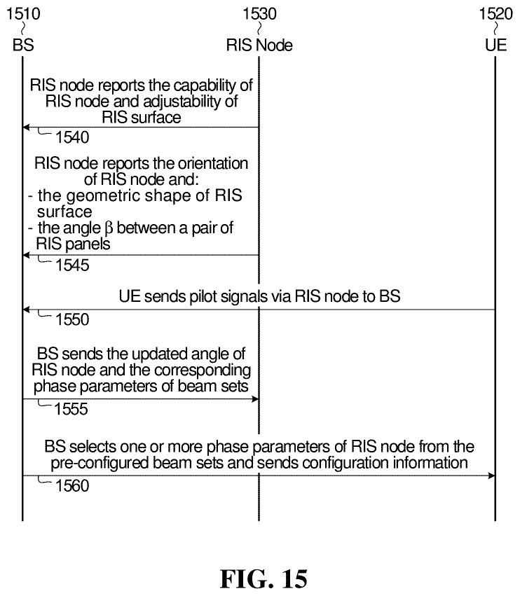

FIG. 15 illustrates an example of signal flow amongst a base station (BS) 1510, a UE 1520 and a RIS node 1530 with one or more adjustable panels or portions.

In step 1540, in a first UL time slot, which may be PUCCH or PUSCH, the RIS node 1530 reports capability information in at least one of a periodic, aperiodic and semi-persistent manner. The capability information may include an indication of whether the RIS-pair may be partitioned into multiple RIS panels, whether each of the RIS panels may be independently and/or jointly controlled and whether one or more panels of the RIS node is adjustable.

Indicating whether the RIS panel is adjustable may include, for the scenario when there are multiple panels, whether the orientations of all panels or part of panels may be adjusted. For the scenario of a single panel, the indication may include an indication of at least one of a geometrical shape of the panel and whether the geometrical shape and orientation of the panel may be adjusted.

In step 1545, in a second UL time slot, which may also be PUCCH or PUSCH, the RIS node 1530 reports orientation of the RIS node and one or both of a geometrical shape of the RIS surface and the relative angle parameter (B) of panels of the RIS node 1530. The information may be reported in a multi-bit signal in at least one of a periodic, aperiodic and semi-persistent manner.

In step 1550, in a third UL time slot, which may be PUCCH or PUSCH, the UE 1520 may send pilot signals via the RIS node 1530 to the base station 1510 to report the information of the UE 1520. For example, reporting the CSI of the channel between the base station 1510 and the UE 1520, capacity of the supporting RIS panels, necessity of using RIS panels and other RIS-related information. Here, it is assumed that UE 1520 already knows the location of RIS panels as a result of the access process or by other sensing information.

After receiving reports from the RIS node 1530 and the UE 1520, the base station 1510 determines phase parameters corresponding to beam sets for the RIS node 1530 based on one or more of 1) the target coverage area of each individual RIS panel and one or more groups of RIS panels, 2) the geometrical shape of at least one RIS panel of the RIS node 1530 and 3) the distribution of UE locations. If the relative angle or the geometrical shape of multiple panels for the RIS node 1530 is adjustable, the base station 1510 may also determine the relative angle between multiple panels for the RIS node 1530. In some embodiments, the angle of the RIS pair may be a quantized value as opposed to an exact angle.

At step 1555, the base station 1510 sends, in a first DL time slot, which may be PDCCH or PDSCH, updated configuration information to the RIS node 1530, such as the updated relative angle of RIS panels of the RIS node, when there are two RIS panels such as shown in FIG. 13, and the corresponding phase parameters of beam sets for BM/CSI/Data transmission. In some embodiments, the phase parameters of beam sets may be provided in a table of quantization.

An example relationship for quantized relative angle and beam indices of beam sets for a particular target cover area of 90° to 100° is shown in Table 9 below. While Table 9 is for the particular range of 90° to 100°, it is to be understood that this is merely by way of example and information may be provided for different angular size of coverage areas between 0° to 180°.

TABLE 9

| | | Beam index for RIS |
|---|---|---|
| Target coverage area | Relative angle (β) | node |
| 90° to 100° | 30° | 0, 1, 2, 3 |
| | 45° | 1, 2, 3, 4 |
| | 70° | 6, 7, 8, 9 |

At step 1560, the base station 1510 selects one or more of the phase parameters for the RIS node 1530 from the pre-configured beam sets and sends, in a second DL time slot, which may be PDCCH or PDSCH, configuration information including the index of beam set, time-frequency resource and other information of RIS panels to the UE 1520 for BM/CSI/Data transmission that the UE 1520 may need for receiving a signal that is redirected by the RIS 1530.

While steps 1555 and 1560 are shown in a particular order, it is to be understood that these steps could be implemented in a different order or substantially simultaneously.

In some embodiments, a combination of a suitable panel shape and/or angle that are optimized by the base station may provide improved performance as compared to the case of only optimizing one of the shape and the angle independent of one another.

In some embodiments, the RIS node has a specific arrangement of panels for different time slots, UL and DL, respectively. The RIS panels of the RIS node may be categorized as two types of RIS panel, a master and a secondary. The master refers to a first panel that receives a signal that is for configuring the master and for configuring of one or more second panels, that are referred to as secondaries.

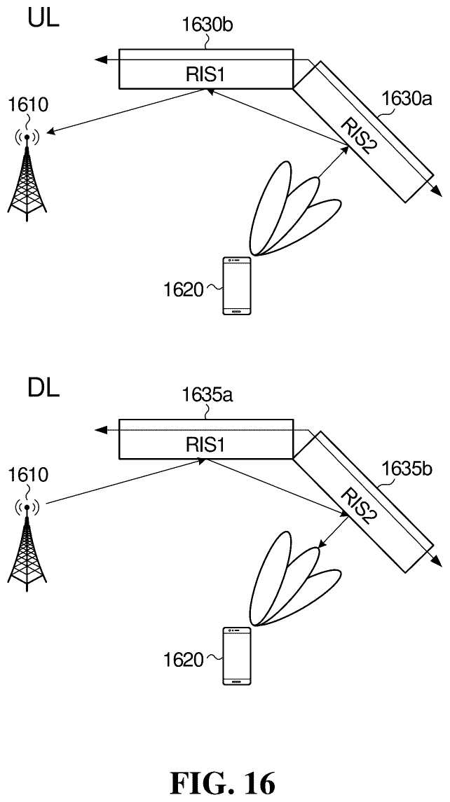

FIG. 16 illustrates a first example of an UL transmission scenario between a UE 1620 and a base station 1610 via a multi-panel RIS node and a second example of a DL transmission scenario between the base station 1610 and the UE 1620 via a multi-panel RIS node. In the UL transmission scenario, the UE 1620 transmits a signal toward RIS-2, acting as a master panel 1630a and then RIS-2 redirects the signal to RIS-1, acting as a secondary panel 1630b and the secondary panel 1630b redirects the signal on to the base station 1610. In the DL transmission scenario, the base station 1610 transmits a signal toward RIS-1, acting as a master panel 1635a and then RIS-1 redirects the signal to RIS-2, acting as a secondary panel 1635b, which and the secondary panel 1635b redirects the signal on to the UE 1620.

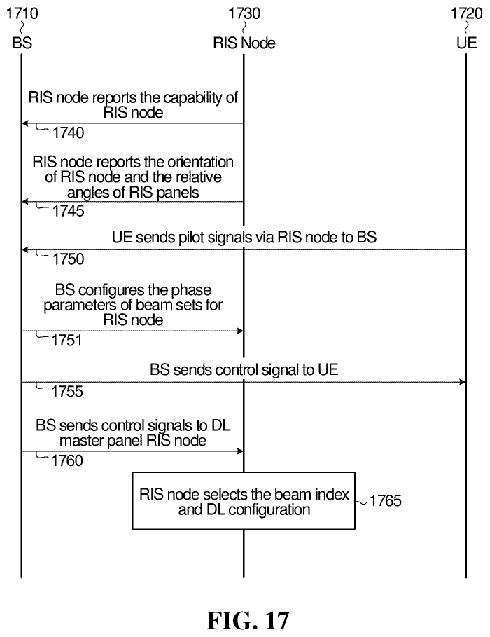

FIG. 17 illustrates an example of signal flow amongst a base station (BS) 1710, a UE 1720 and a single panel partitioned into multiple portion or multiple panel RIS node 1730 for a DL transmission scenario.

Step 1740 is similar to step 540 in FIG. 5. Step 1745 is similar to step 845 in FIG. 8. Step 1750 is similar to step 550 in FIG. 5.

In step 1751, when UL transmission is done, the base station 1710 configures the phase parameters for beam sets for the RIS node 1730, which depends on the information from the RIS node 1730 and the UE 1720. Several possible approaches to configure the phase parameters of the RIS panels by the base station 1710 are provided below. However, other approaches may be implemented as well.

In some embodiments, the base station 1710 determines the phase parameters of the RIS node 1730 based on target coverage holes and the orientation of the RIS node 1730. In some embodiments, the phase parameters of beam sets for the master RIS panel may be determined based on the channel information. The phase parameter information may be associated with the phase parameters of the secondary RIS panel(s). In some embodiments, the phase parameters of beam sets for only the secondary panels may be determined by the RIS node 1730.

Step 1755 is similar to step 555 in FIG. 5 or step 855 in FIG. 8.

At step 1760, the base station 1710 sends a single control signaling, in a first DL time slot, which may be PDCCH or PDSCH, to the RIS node 1730 for BM/CSI/Data transmission. This control signaling may contain at least the beam index or the phase parameter for the master panel for the DL transmission scenario. However, other information may be sent as well.

While steps 1755 and 1760 are shown in a particular order, it is to be understood that these steps could be implemented in a different order or substantially simultaneously.

Tables 10 and 11 show examples of configuration information that may be determined and sent by the base station 1710. Table 10 includes configuration for a single beam identified by a single beam index. Table 11 includes configuration for multiple beams identified by a group of beam indices. Reference to master and secondary time slot, beam index for each type in Tables 10 and 11 are not intended to be limited to these examples.

TABLE 10

| | | | | Beam index |
|---|---|---|---|---|
| | | Time slot | Beam index | (Secondary, |
| Master | Secondary | (indicated) | (Master) | indicated) |
| RIS1 | RIS2 | DL | 1 | 2 |
| RIS2 | RIS1 | UL | 5 | 6 |

TABLE 11

| | | | | Beam indexes |
|---|---|---|---|---|
| | | Time slot | Beam index | (Secondary, |
| Master | Secondary | (indicated) | (Master) | indicated) |
| RIS1 | RIS2 | DL | 1 | 2, 3, 4 |
| RIS2 | RIS1 | UL | 5 | 6, 7, 8 |

The configuration information may be sent in a dynamic manner in DCI or MAC CE. The configuration information may contain the configuration information for the master panel and then configuration information for the secondary panels that is associated with the configuration information for the master panel may be stored in the RIS node 1730. In some embodiments, selection of the master panel may also implicitly indicate an UL or DL time slot and thereby aid the RIS node 1730 in configuring additional parameters at the RIS node 1730. Examples of additional parameters may be time synchronizing with the UE 1720 and the base station 1710 or a time slot for phase shifting to serve different UEs.

Once the RIS node 1730 has received the configuration information in step 1760, at step 1765, the RIS node 1730 may select a beam from the pre-calculated beam sets and DL configuration based on the configuration information.

While FIG. 17 is directed to a DL transmission scenario, it is understood that the method can be easily modified for an UL transmission scenario.

In some embodiments, control between the master panel and the secondary panel is predetermined for the RIS node, i.e. there is an association for secondary panels based on configuration information received by the RIS node for the master panel. Once the master panel receives control signaling, the secondary panels may be configured automatically based on the known association. Such implementation may reduce the amount of air interface resources needed for configuring the RIS node. In some embodiments, indicating which panel is a master panel may inferentially inform the RIS node about whether UL or DL signaling will be occurring.

In some embodiments, each panel of the RIS node may be configured to either reflect or steer (or tune) a signal that impinges upon the panel. Using a combination of reflecting and/or steering a beam may provide a higher freedom for the RIS node to improve the possible coverage area.

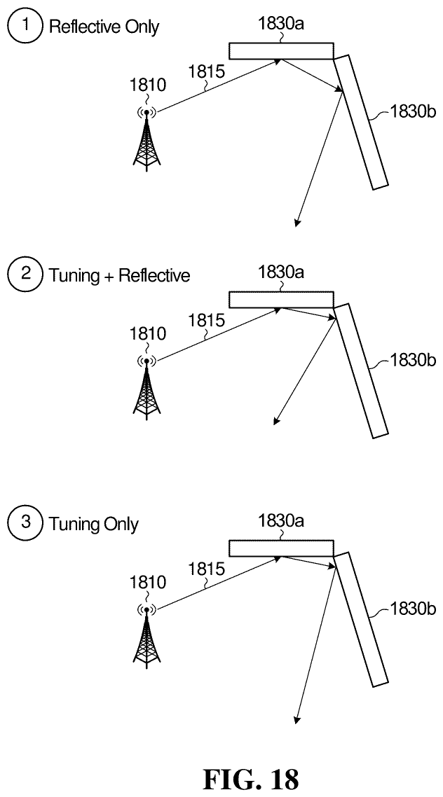

FIG. 18 illustrates several different examples for controlling different panels of a multi-panel RIS node 1830 for a DL transmission scenario between a base station 1810 and a UE 1820 via the multi-panel RIS node 1830 The multi-panel RIS node 1830 has a first panel 1830a and a second panel 1830b. In the first example illustrating only reflective redirecting in FIG. 18, a beam 1815 that is transmitted from the base station 1810 may be reflected by a first panel 1830a directly to a destination. In addition or alternatively, the first panel 1830a reflects the beam to the second panel 1830b, which also reflects the beam towards the destination. In a second example illustrating both tuning and reflective redirecting, in FIG. 18, a beam 1815 is transmitted from the base station 1810 is steered by phase tuning at the first panel 1830a to the second panel 1830b, which reflects the beam towards the destination. In a third example illustrating only tuning redirecting, in FIG. 18, a beam 1815 that is transmitted from the base station 1810 is steered by phase tuning at the first panel 1830a to the second panel 1830b, which also steers the beam by using phase tuning towards the destination.

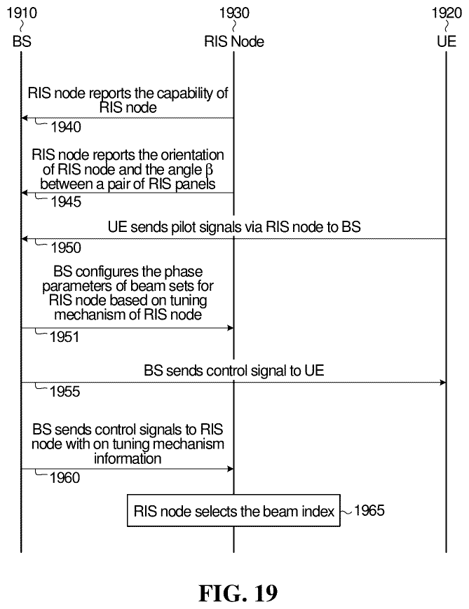

FIG. 19 illustrates an example of signal flow amongst a base station (BS) 1910, a UE 1920 and a single panel partitioned into multiple portion or multiple panel RIS node 1930.

Step 1940 is similar to step 540 in FIG. 5 or step 840 in FIG. 8 . . . . Step 1945 is similar to step 845 in FIG. 8. Step 1950 is similar to step 550 in FIG. 5 or step 850 in FIG. 8.

In step 1951, after the base station 1910 receives reports from the RIS node 1930 and the UE 1920, the base station 1910 determines the phase parameters of beam sets for the RIS mode 1930, which depends on the information from the RIS node 1930 and the UE 1920. Several possible approaches to configure the phase parameters of the RIS panels by the base station 1910 are provided below. However, other approaches may be implemented as well.

In some embodiments, the phase parameters may be based on a RIS parameter tuning mechanism, e.g. reflection only, tuning only and reflection and tuning. In some embodiments, the phase parameters and tuning state may depend on optimizing for a single UE or a specific coverage area.

With regard to the tuning state, as shown in FIG. 18, the tuning state may be different for each panel. Table 12 shows an example of relationships of tuning state and phase parameters of beam sets for a specific UE. Table 13 shows an example of relationships of tuning state and phase parameters of beam sets for a wider cover area. In Tables 12 and 13, the configuration information for the four different relationships that are included in each table can be expressed with two bits, i.e. 00, 01, 10, 11, as these two bits substantially correspond to an index associated with each relationship. For scenarios with more than four relationships, more than two bits may be used to send the configuration to the UE. Reference to tuning mechanism and beam index information in Tables 12 and 13 are not intended to be limited to these examples.

TABLE 12
Single UE case

| Configuration | | Beam index for RIS- |
|---|---|---|
| information | Tuning mechanism | pair |
| 00 | RIS1 reflection; RIS2 reflection | 1 |
| 10 | RIS1 tuning; RIS2 reflection | 4 |
| 11 | RIS1 tuning; RIS2 tuning | 10 |
| 01 | RIS1 reflection; RIS2 tuning | 12 |

TABLE 13
Specific Cover Area

| Configuration | | Beam index for RIS- |
|---|---|---|
| information | Tuning mechanism | pair |
| 00 | RIS1 reflection; RIS2 reflection | Beam sets: 0~3 |
| 10 | RIS1 tuning; RIS2 reflection | Beam sets: 4~7 |
| 11 | RIS1 tuning; RIS2 tuning | Beam sets: 8~11 |
| 01 | RIS1 reflection; RIS2 tuning | Beam sets: 12~15 |

Step 1955 is similar to step 655 in FIG. 6 or step 855 in FIG. 8.

At step 1960, the base station 1910 sends a single control signaling to the RIS node 1930 for BM/CSI/Data transmission. This control signaling may contain at least one of the tuning state information and phase parameters or beam index of each RIS panel. However, other information may be sent as well. For the tuning state information, several bits may be used to represent the tuning state of each panel. For example, “o” may represent reflection and “1” may represent tuning. The control signaling may be sent in at least one of a periodic, aperiodic and semi-persistent way depending on the communication requirement.

In some embodiments, the configuration information may be sent in a dynamic manner in DCI or MAC CE.

While steps 1955 and 1960 are shown in a particular order, it is to be understood that these steps could be implemented in a different order or substantially simultaneously.

Once the RIS node 1930 has received the configuration information in step 1960, at step 1965, the RIS node 1930 may select a beam from the pre-calculated beam sets based on the UE location included in the configuration information.

In some embodiments, the ability to configure the RIS panel for reflecting, steering (tuning) or a combination of reflecting and steering (tuning) may enable a more flexible way to control the RIS node resulting in improved transmission quality. RIS panels of the RIS node may be configured to act in either a reflection state or in a tuning state, which may enable a higher degree of freedom for the RIS node.

While the various embodiments described above are described individually, it is to be understood that aspect of the different embodiments may be implemented in combination with one another. For example, the base station may perform partition the cell into sub-areas and the RIS node may have a surface with a geometric shape that is adjustable, or the base station determines configuration information about a target coverage area of the individual RIS panels of an RIS node and the RIS node treats one panel as a master and other panels as a secondary. Therefore, while steps are described in the various embodiments above as including transmission of specific information, if multiple embodiments are combined, multiple pieces of configuration may be sent together or in close proximity.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
sending, by a reconfigurable intelligent surface (RIS) node, capability information of the RIS node, wherein the RIS node comprises at least a first portion of a first surface and a second portion of a second surface, and wherein the first portion of the first surface is configurable to redirect a signal to the second portion of the second surface;
sending, by the RIS node, information pertaining to beam sets or orientation of at least one of the first portion of the first surface or the second portion of the second surface;
receiving, by the RIS node, control signal from a base station for controlling operation of the RIS node; and
redirecting, by the RIS node, signals from a user equipment (UE) to a base station or from a base station to a user equipment based on the control signal.

2. The method of claim 1, wherein the capability information of the RIS node comprises at least one of:
an indication of whether the RIS node is able to be partitioned into multiple portions;
when there are at least two RIS portions, an indication of whether the first portion of the first surface and the second portion of the second surface are independently or jointly controlled; and
adjustability of the first portion of the first surface and the second portion of the second surface.

3. The method of claim 1, wherein the information pertaining to beam sets comprises, for each beam set, a set index value for identifying the beam set, a number of beams in the beam set, and one or more RIS portions the beam set is associated with.

4. The method of claim 1, wherein the information pertaining to orientation of at least one of the first portion of the first surface or the second portion of the second surface comprises at least one of:
an angle between the first portion of the first surface and the second portion of the second surface; or
a geometrical shape of the first portion of the first surface and the second portion of the second surface.

5. The method of claim 1, wherein the control signal for controlling operation of the RIS node comprises one or more of:
when there are at least two RIS portions, an indication of whether the first portion of the first surface and the second portion of the second surface are independently or jointly controlled;
a set index for identifying a selected beam set to be used by each of the first portion of the first surface and the second portion of the second surface;
a beam or beam group in the selected beam set to be used by each of the first portion of the first surface and the second portion of the second surface;
an indication of a location of a UE or UE group; or
a location of the UE.

6. A device, comprising:
at least a first portion of a first surface and a second portion of a second surface, wherein the first portion of the first surface is configurable to redirect a signal to the second portion of the second surface;
one or more processors, wherein when executing program instructions stored in the device, the one or more processors cause the device to:
send capability information of the device;
send information pertaining to beam sets or orientation of at least one of the first portion of the first surface or the second portion of the second surface;
receive control signal from a base station for controlling operation of the device; and
redirect signals from a user equipment (UE) to a base station, or from a base station to a UE, based on the control signal.

7. The device of claim 6, wherein the capability information of the device comprises at least one of:
an indication of whether the device is able to be partitioned into multiple portions;
when there are at least two device portions, an indication of whether the first portion of the first surface and the second portion of the second surface are independently or jointly controlled; and
adjustability of the first portion of the first surface and the second portion of the second surface.

8. The device of claim 6, wherein the information pertaining to beam sets comprises, for each beam set, a set index value for identifying the beam set, a number of beams in the beam set, and one or more device portions the beam set is associated with.

9. The device of claim 6, wherein the information pertaining to the orientation of at least one of the first portion of the first surface or the second portion of the second surface comprises at least one of:
an angle between the first portion of the first surface and the second portion of the second surface; or
a geometrical shape of the first portion of the first surface and the second portion of the second surface.

10. The device of claim 6, wherein the control signal for controlling operation of the device comprises one or more of:
an indication of whether the first portion of the first surface and the second portion of the second surface are independently or jointly controlled;
a set index for identifying a selected beam set to be used by each of the first portion of the first surface and the second portion of the second surface;
a beam or beam group in the selected beam set to be used by each of the first portion of the first surface and the second portion of the second surface;
an indication of a location of a UE or UE group; or
a location of the UE.

11. A method comprising:
receiving, by a base station, capability information of a reconfigurable intelligent surface (RIS) node, wherein the RIS node comprises at least a first portion of a first surface and a second portion of a second surface, and wherein the first portion of the first surface is configurable to redirect a signal to the second portion of the second surface;
receiving, by the base station, information pertaining to beam sets or orientation of at least one of the first portion of the first surface or the second portion of the second surface; and
transmitting, by the base station, a control signal to the RIS node for controlling operation of the RIS node.

12. The method of claim 11, wherein the capability information comprises at least one of:
an indication of whether the RIS node is able to be partitioned into multiple RIS portions;
when there are at least two RIS portions, an indication of whether the first portion of the first surface and the second portion of the second surface are independently or jointly controlled; and
adjustability of a surface of the first portion of the first surface and the second portion of the second surface.

13. The method of claim 11, wherein the information pertaining to the beam sets comprises, for each beam set, a set index value for identifying the beam set, a number of beams in the beam set and one or more RIS portions the beam set is associated with.

14. The method of claim 11, wherein the information pertaining to the orientation of at least one of the first portion of the first surface or the second portion of the second surface comprises at least one of:
an angle between the first portion of the first surface and the second portion of the second surface; or
a geometrical shape of the first portion of the first surface and the second portion of the second surface.

15. The method of claim 11, wherein the control signal for controlling operation of the RIS node comprises one or more of:
when there are at least two RIS portions, an indication of whether the first portion of the first surface and the second portion of the second surface are independently or jointly controlled;
a set index for identifying a selected beam set to be used by each of the first portion of the first surface and the second portion of the second surface;
a beam or beam group in the selected beam set to be used by each of the first portion of the first surface and the second portion of the second surface;
an indication of a location of a UE or UE group; or
a location of the UE.

16. A device, comprising:
at least a first portion of a first surface and a second portion of a second surface, wherein the first portion of the first surface is configurable to redirect a signal to the second portion of the second surface;
one or more processors, wherein when executing program instructions stored in the device, the one or more processors cause the device to:
receive capability information of a reconfigurable intelligent surface (RIS) node comprising at least a first portion of a first surface and a second portion of a second surface, wherein the first portion of the first surface is configurable to redirect a signal to the second portion of the second surface;
receive information pertaining to beam sets or orientation of at least one of the first portion of the first surface or the second portion of the second surface; and
transmit a control signal to the RIS node for controlling operation of the RIS node.

17. The device of claim 16, wherein the capability information comprises at least one of:
an indication of whether the RIS node is able to be partitioned into multiple RIS portions;
an indication of whether the first portion of the first surface and the second portion of the second surface are independently or jointly controlled; and
adjustability of a surface of the first portion of the first surface and the second portion of the second surface.

18. The device of claim 16, wherein the information pertaining to beam sets comprises, for each beam set, a set index value for identifying the beam set, a number of beams in the beam set and one or more RIS portions the beam set is associated with.

19. The device of claim 16, wherein the information pertaining to the orientation of at least one of the first portion of the first surface or the second portion of the second surface comprises at least one of:
an angle between the first portion of the first surface and the second portion of the second surface; and
a geometrical shape of the first portion of the first surface and the second portion of the second surface.

20. The device of claim 16, wherein the control signal for controlling operation of the RIS node comprises one or more of:
an indication of whether the first portion of the first surface and the second portion of the second surface are independently or jointly controlled;
a set index for identifying a selected beam set to be used by each of the first portion of the first surface and the second portion of the second surface;
a beam or beam group in the selected beam set to be used by each of the first portion of the first surface and the second portion of the second surface;
an indication of a location of a UE or UE group; or
a location of the UE.
